(19) United States
(12) Patent Application Publication
(10) Pub. No.: US 2015/0131273 A1
(43) Pub. Date: May 14, 2015

(54) Bottle Illuminating Base

(71) Applicant: Rodney E. Jackson, Miami, FL (US)

(72) Inventor: Rodney E. Jackson, Miami, FL (US)

(21) Appl. No.: 14/536,378

(22) Filed: Nov. 7, 2014

Related U.S. Application Data
(60) Provisional application No. 61/901,919, filed on Nov. 8, 2013.

(51) Int. Cl. F21V 23/06; F21V 23/04; F21L 4/00; F21V 23/00; F21V 23/02

(52) U.S. Cl. CPC F21V 23/06; F21V 23/004; F21V 23/023; F21L 4/00; F21V 23/0414; F21W 2131/30
USPC 362/157

(57) ABSTRACT

A device for illuminating bottles provides a housing with an upper casing and a lower casing that serve to enclose electrical components. The electrical components include a power source, illumination source, and a circuit which electrically connects said power source and illumination source. A three-way switch allows a user to configure the illumination source and circuit, selecting between three settings. The three-way switch is thus electrically connected between the power source and illumination source by means of the circuit. A secondary switch enables operation of a variable state, in which the illumination source turns off or on depending on if it is placed on a table or lifted from a table. The housing is coupled to a bottle by a bottle receiving portion on the upper casing, which is dome shaped in order to allow for an interference fit. The device is used to illuminate a secured bottle.

The current application claims a priority to the U.S. Provisional Patent application Ser. No. 61/901,919 filed on Nov. 8, 2013.

### FIELD OF THE INVENTION

The present invention relates generally to an apparatus that can be coupled to a bottle or similar item and externally illuminates said coupled item.

### BACKGROUND OF THE INVENTION

Illumination devices have found a number of applications during their lifetime, both for utilitarian and aesthetic purposes. The present invention expands upon the aesthetic benefits of illumination devices and specifically concerns itself with light emitting diodes (LED lighting), though other types of illumination sources are equally applicable. The present invention's focus on LED lighting is due to their numerous benefits, which include superior brightness, extended lifetimes, and reduced energy costs compared to other lighting solutions.

The present invention is applicable in a number of fields, an example of which is alcohol related services. The present invention can be used to illuminate a bottle of alcohol, visually enhancing the drinking experience. This enhancement is even more profound in dimly lit areas such as clubs and similar venues. The present invention also provides the ability to turn on and off based on pressure, such that it only illuminates a bottle when the bottle is removed from a table. This is another way the present invention improves upon alcohol related businesses and experiences.

The present invention is not meant to be limited to lighting bottles, and is capable of being used for general home decoration or even functional area lighting, similar to a lamp. Due to its compact size the present invention can be utilized as a portable lighting device, along with the primary function of illuminating bottles.

It is therefore an object of the present invention to provide an apparatus which can easily be coupled to a bottle and which is capable of illuminating the bottle according to settings as configured by a user.

### BRIEF DESCRIPTION OF THE DRAWINGS

FIG. 1 is an illustration of an upper casing of a housing of the present invention.

FIG. 2 is an illustration of a lower casing of the housing of the present invention.

FIG. 3 is a lateral section view showing the present invention in conjunction with a bottle.

FIG. 4 is a top plan view showing the present invention with a three-way switch in a first setting.

FIG. 5 is a top plan view showing the present invention with a three-way switch in a second setting.

FIG. 6 is a top plan view showing the present invention with a three-way switch in a third setting.

FIG. 7 is an exploded view of the present invention.

FIG. 8 is a flowchart demonstrating potential electrical pathways for the present invention.

### DETAIL DESCRIPTIONS OF THE INVENTION

All illustrations of the drawings are for the purpose of describing selected versions of the present invention and are not intended to limit the scope of the present invention.

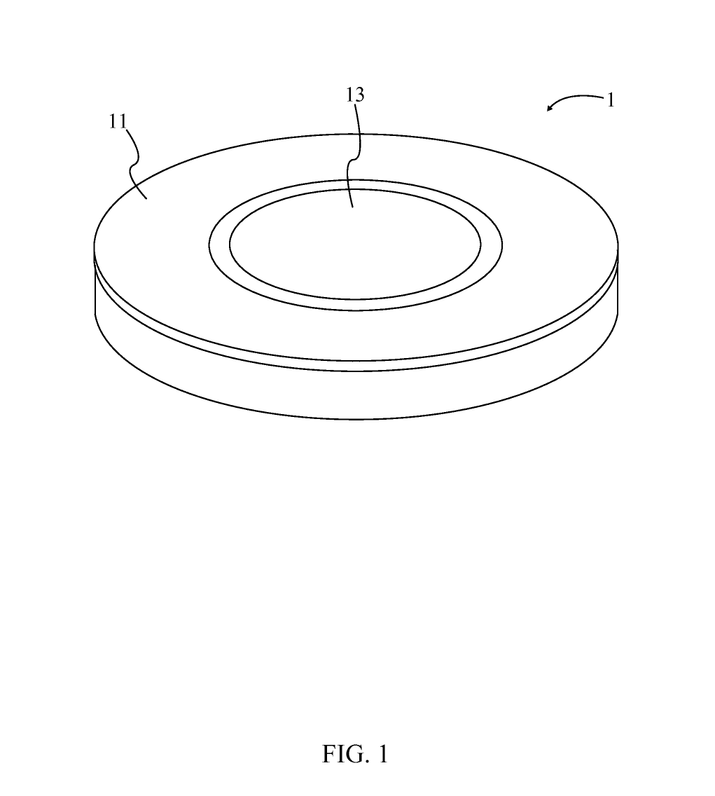

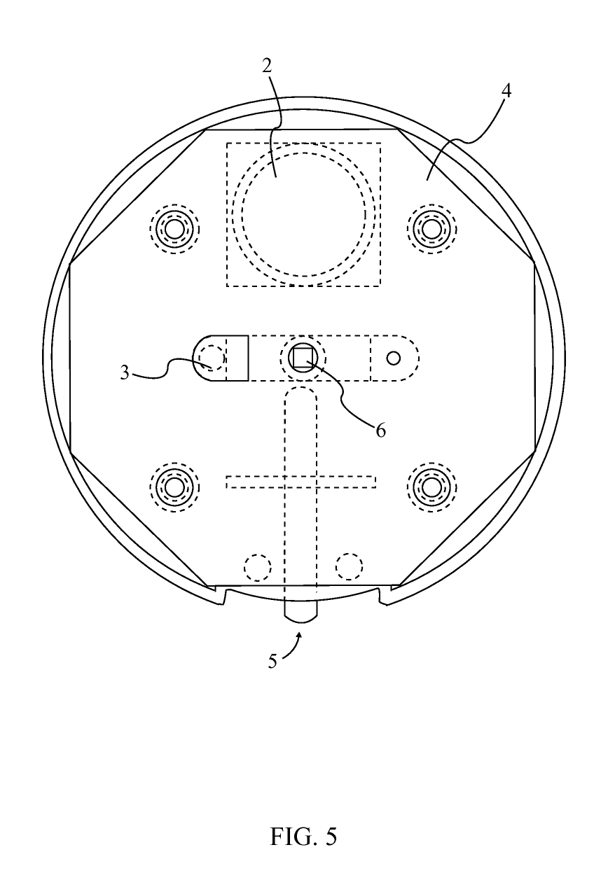

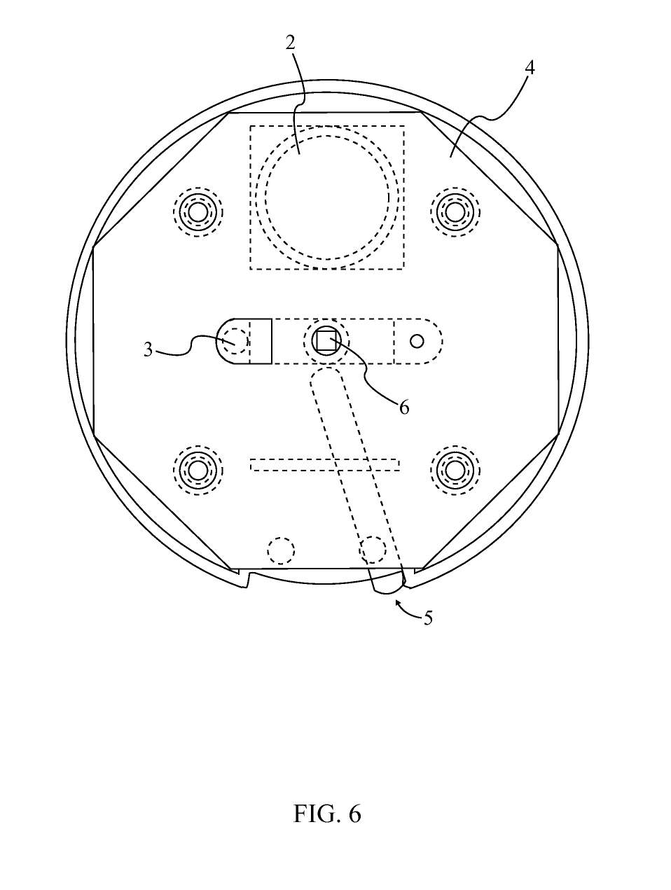

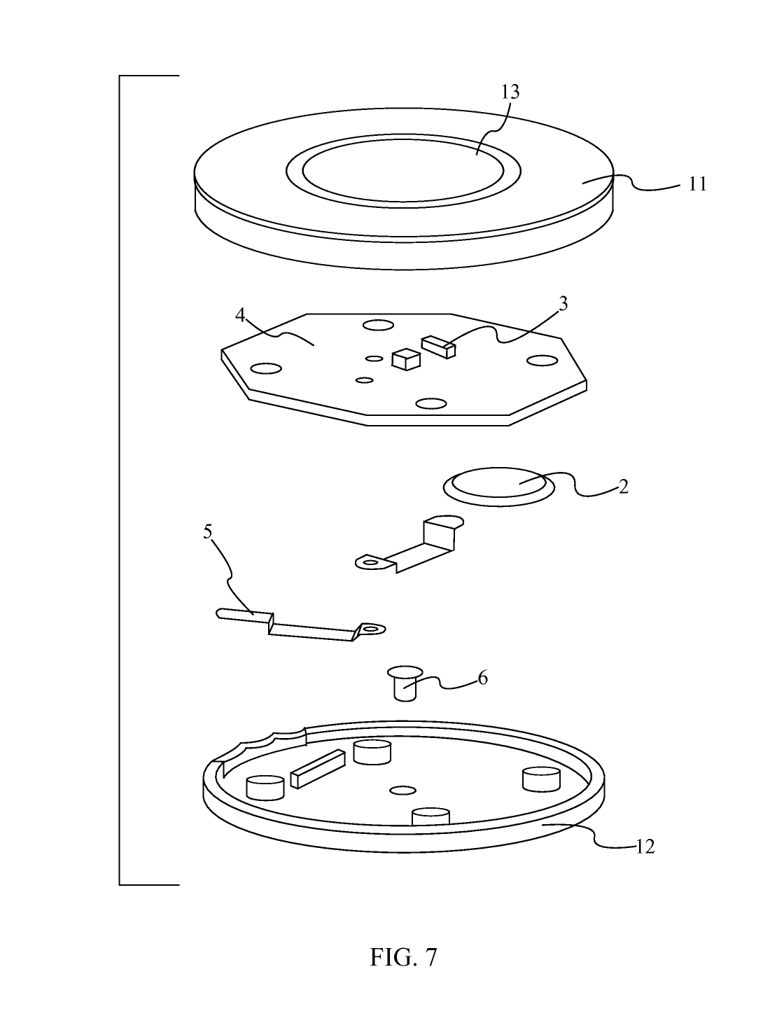

The present invention is an apparatus for interfacing with and visually enhancing bottles, most commonly those containing spirits and other alcohols. The present invention is designed to attach to an illuminate a bottle, either continuously or selectively (i.e. only when not resting on a rigid surface) depending on how a user configures the present invention. An embodiment of the present invention is provided in FIG. 1-FIG. 8.

The present invention comprises a housing 1, a power source 2, an illumination source 3, a circuit board 4, a three-way switch 5, and a secondary switch 6. The housing 1 serves to enclose the other components of the present invention, as well as allow the present invention to couple with a punt of a bottle. The power source 2 supplies the necessary energy for the electrical components of the present invention, primarily the illumination source 3 by means of the circuit board 4. The illumination source 3 lights up a coupled bottle in a manner that aesthetically enhances the drinking experience, especially in dark areas such as clubs or bars. The three-way switch 5 and secondary switch 6 are electrically connected with the circuit board 4 and allow a user to change configurations (e.g. switching the illumination source 3 on or off) as desired.

More specifically, the three-way switch 5 is electrically connected in series between the illumination source 3 and the power source 2; the switch can be opened or close to complete or break the lighting circuit, effectively allows a user to turn the illumination source 3 on or off. A third setting can also be provided, where the illumination source 3 is activated only when lifted from a surface (i.e. a bottle with the present invention is lifted off a table or similar surface). To enable this third setting, the secondary switch 6 is interacts with the three-way switch 5 and circuit board 4; when the secondary switch 6 is engaged (i.e. the present invention is placed on a flat surface) it breaks the lighting circuit. When the secondary switch 6 is disengaged from the lighting circuit (i.e. the present invention is lifted from a surface), it allows the lighting circuit to be completed and the illumination source 3 to be turned on.

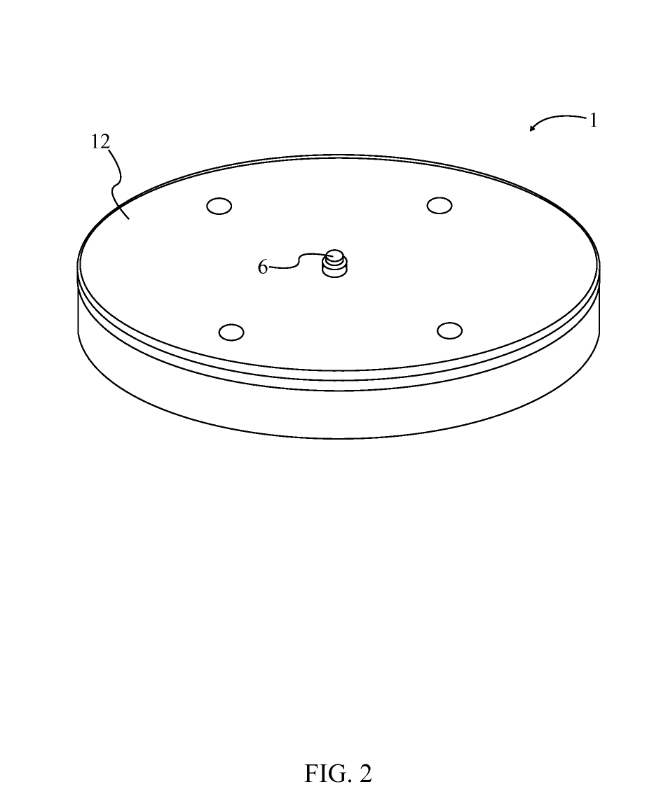

The power source 2, illumination source 3, and circuit board 4 are protected from environmental factors by being positioned within the housing 1, minimizing dust accumulation, susceptibility to water, and similar exposure to potential hazards. In order to secure these components, preventing undesired movement and ensuring they maintain the proper configuration with respect to other components, the power source 2, illumination source 3, and circuit board 4 are secured to the interior of the housing 1. The housing 1 itself can be formed from two separate pieces, allowing the other components to be placed inside the housing 1. The housing 1 thus comprises an upper casing 11 (FIG. 1) and a lower casing 12 (FIG. 2) which respectively form the respective top and bottom of the housing 1. The upper casing 11 and lower casing 12 are perimetrically connected to each other in order for form an enclosed interior, suitable for mounting and protecting other components of the present invention.

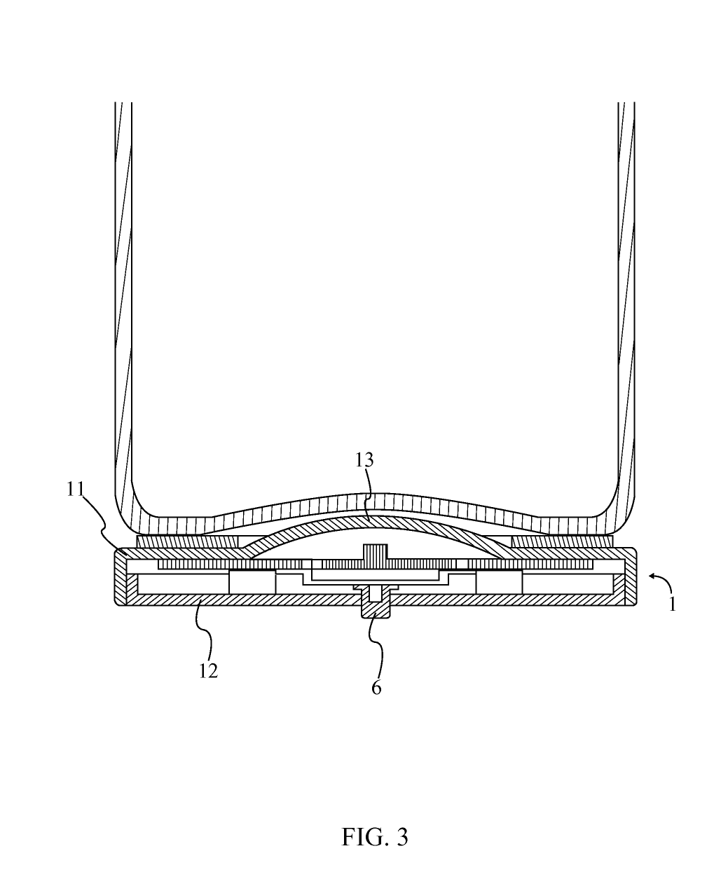

The lower casing 12 can be given a planar bottom surface and lateral wall connected around the planar bottom surface. The planar bottom surface allows the lower casing 12 to be securely placed on a table; the bottom surface could potentially be convex or indeed a number of other shapes. However, these alternative options are prone to rocking or undesired shifting and are not ideal for the present invention. The upper casing 11, conversely, serves as a coupling point for a punt of a bottle and thus is provided with a bottle receiving portion 13. The upper casing 11 also has a lateral wall which is coincident with the lateral wall of the lower casing 12, allowing the upper casing 11 and lower casing 12 to be joined to each other at their corresponding lateral walls. The bottle receiving portion 13 is integrated into the upper casing 11 as a convex section that is elevated above the rest of the upper casing 11 (i.e. the external surface of the upper casing 11) and is shaped to mate with the punt of the bottle by means of an interference fit. The bottle receiving portion 13 effectively appears as a dome that rises above the upper casing 11. By pressing the bottle receiving portion 13 against the punt, frictional forces act to couple the present invention with the punt and thus the bottle, such as shown in FIG. 3. For the best alignment between the present invention and the bottle, the bottle receiving portion 13 is centered with respect to the upper casing 11.

To provide greater adaptability, the bottle receiving portion 13 could alternatively be implemented as a lip that is connected around the upper casing 11. This flexible lip, rather than engaging with the punt of a bottle, is pressed against the lower lateral portion of a bottle. This is another application of an interference fit, using frictional forces to couple the present invention and the bottle. This is just one example of potential alternative coupling method; other embodiments could use replaceable double-sided adhesives, user-actuated clamp mechanisms, or other implementations devised by manufacturers. Ideal solutions will be simple, low cost, and easy to use, such as the illustrated example of a convex feature serving as the bottle receiving portion 13.

As the present invention is meant to illuminate a coupled bottle, the upper casing 11 is transparent in order to allow light from the illumination source 3 to pass through the upper casing 11 and into an adjacent bottle. Alternatively, the illumination source 3 could be externally mounted to housing 1 (whether the upper casing 11, lower casing 12, or both). Additionally, multiple illumination sources 3 can be provided in order to increase the intensity of provided light, or even provide a mixture of different colors. In one potential embodiment, multiple illumination sources 3 are connected around the housing 1, mounted to the lateral walls of the upper casing 11 and potentially even the lower casing 12. While it's possible to directly mount the illumination sources 3 directly onto the bottle receiving portion 13, such a configuration runs the risk of interfering with securing the present invention to a bottle. While the present invention has been illustrated as an embodiment with a single internally positioned illumination source 3, it is not limited to such. In addition to embodiments with multiple exterior illumination sources 3, extra illumination sources 3 may be placed inside the housing 1, or even both within and exterior to the housing 1. Embodiments may alter positioning and number of the illumination source 3 as compared to the illustrated embodiment as long as these embodiments provide illumination sources 3 which are capable of lightning up an adjacent bottle.

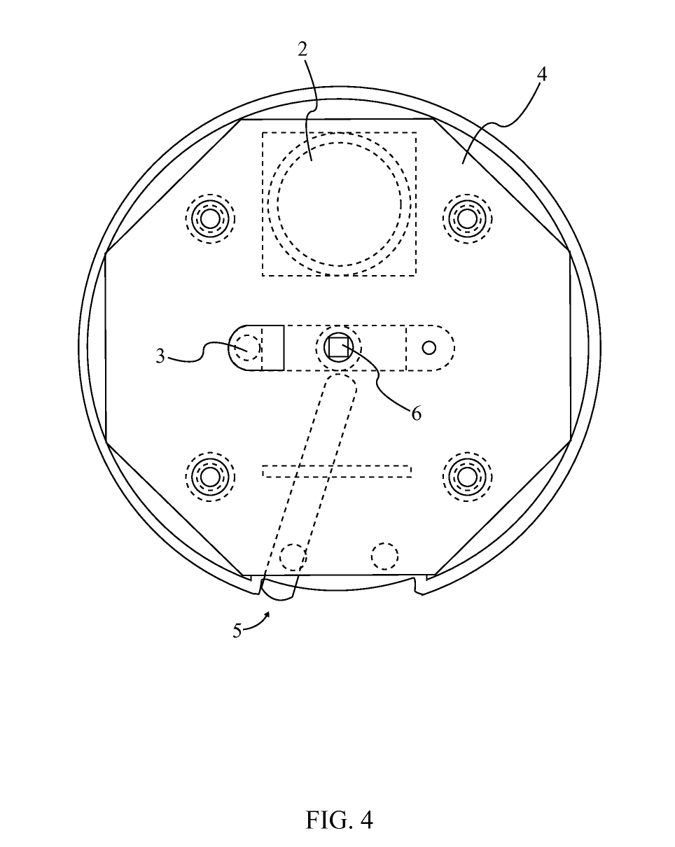

To allow the present invention to operate as intended, a power source 2 is electrically connected to the illumination source 3. This supplies the current necessary for the illumination source 3 to function. Enabling a user to switch the present invention between a number of states is the three-way switch 5. The three-way switch 5 traverses through a lateral portion of the housing 1, such that it is accessible to a user. The three-way switch 5 contacts the circuit board 4, through which it is electrically connected between the illumination source 3 and the power switch. As a result, the three-way switch 5 can be used to configure the present invention in one of three states. In an off-state, the three-way switch 5 is “open”, breaking the circuit between the illumination source 3 and power source 2. In an on-state, the three-way switch 5 is “open”, such that it completes the circuit between the illumination source 3 and power source 2. In a third variable-state, the circuit can be completed or broken depending on the interaction between the three-way switch 5 and the secondary switch 6. The secondary switch 6 and the three-way switch 5 are electrically connected between the power source 2 and the illumination source 3. The secondary switch 6 itself traverses into the housing 1 through the lower casing 12, where it selectively makes contact with the circuit board 4. The secondary switch 6 is configured so that in a default state it completes the electrical circuit, and it becomes “open” (thus breaking the circuit) when pressure is applied to the secondary switch 6. In the described embodiment, this pressure results from the normal force experiences by the switch when the present invention is placed on a table. In other words, the secondary switch 6 is pressure sensitive, such that if the housing 1 is placed on the ground, the normal force causes the secondary switch 6 to disengage from the circuit and cause the illumination source 3 to turn off. The three settings of the three-way switch 5 are shown in FIG. 4-FIG. 6.

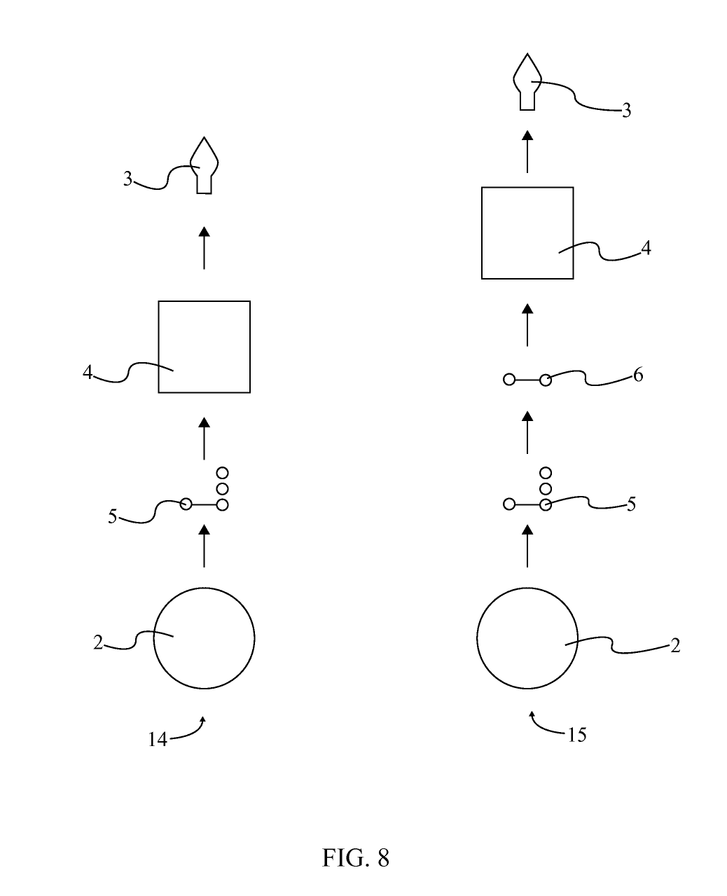

These three states are enabled by the previously described electrical connections, which can be summed up as a first electrical pathway 14 and a second electrical pathway 15 of the three-way switch 5. The illumination source 3 and power source 2 are electrically connected to each other through either of these pathways; if both pathways are open (also referred to as “broken”) power is not supplied to the illumination source 3. If either pathway is closed (also referred to as “complete”) then the power source 2 supplies the necessary energy to run the illumination source 3. The first electrical pathway 14 joins the illumination source 3 and power source 2 through an electrical series connection, by means of the three-way switch 5. The second pathway joins the illumination source 3 and power source 2 in a similar manner, but instead runs through both the three-way switch 5 and the secondary switch 6, rather than only the three-way switch 5. While these are the pathways used to implement the on, off, and variable states of the present invention as with the described embodiment, other embodiments may utilize alternative electrical connections and configurations to obtain the same results. An example of these connections is provided through FIG. 8.

In the illustrated embodiment, the three-way switch 5 is of a toggle design while the secondary switch 6 is of a button design. In alternative embodiments, different types of switches may be utilized as desired. Furthermore, different circuit configurations can be utilized as long as they allow for three states to be selected (i.e. through the three-way switch 5), one of which is selectively enabled or disabled by the secondary switch 6. The intended results is that a user can alternate the present invention between an on-state (where the illumination source 3 remains active at all times), an off-state (where the illumination source 3 remains inactive at all times), and a variable-state (where the illumination source 3 alternates between active and inactive as the present invention is held by a user or placed on a table, respectively).

Although the invention has been explained in relation to its preferred embodiment, it is to be understood that many other possible modifications and variations can be made without departing from the spirit and scope of the invention as hereinafter claimed.

What is claimed is:

1. A bottle illuminating base comprises:
a housing;
a power source;
an illumination source;
a circuit board;
a three-way switch;
a secondary switch;
a bottle receiving portion;
the housing comprises an upper casing and a lower casing;
the power source, the illumination source, and the circuit board being positioned within the housing
the bottle receiving portion being integrated into the upper casing;
the upper casing being transparent;
the illumination source being electrically connected in series to the power source, the circuit board, and the three-way switch;
the secondary switch being electrically connected in series between the power source and the three-way switch;
the three-way switch laterally traversing into the housing; and
the secondary switch being externally mounted to the lower casing.

2. The bottle illuminating base as claimed in claim 1 comprises:
the power source, the illumination source, and the circuit board being internally mounted to the housing.

3. The bottle illuminating base as claimed in claim 1 comprises:
the bottle receiving portion being externally integrated into the upper casing opposite the lower casing; and
the bottle receiving portion being centrally positioned on the upper casing.

4. The bottle illuminating base as claimed in claim 3 comprises:
the bottle receiving portion being dome-shaped, wherein the bottle receiving portion is pressed against a punt of a bottle via interference fit.

5. The bottle illuminating base as claimed in claim 1 comprises:
the upper casing and the lower casing being perimetrically connected to each other.

6. The bottle illuminating base as claimed in claim 1, wherein the upper casing and an affixed bottle are illuminated by the illumination source.

7. The bottle illuminating base as claimed in claim 1 comprises:
the three-way switch being a toggle switch.

8. The bottle illuminating base as claimed in claim 1 comprises:
the secondary switch being a button switch.

9. The bottle illuminating base as claimed in claim 1 comprises:
the three-way switch comprises a first electrical pathway and a second electrical pathway;
the illumination source and the power source being electrically connected in series through the first electrical pathway, wherein actuating the three way switch completes or breaks the first electrical pathway;
the illumination source, the secondary switch, and the power source being electrically connected in series through the second electrical pathway, wherein actuating the secondary switch completes or breaks the second electrical pathway;

10. A bottle illuminating base comprises:
a housing;
a power source;
an illumination source;
a circuit board;
a three-way switch;
a secondary switch;
a bottle receiving portion;
the housing comprises an upper casing and a lower casing;
the power source, the illumination source, and the circuit board being positioned within the housing;
the bottle receiving portion being integrated into the upper casing;
the bottle receiving portion being externally integrated into the upper casing opposite the lower casing;
the upper casing being transparent;
the illumination source being electrically connected in series to the power source, the circuit board, and the three-way switch;
the secondary switch being electrically connected in series between the power source and the three-way switch;
the three-way switch laterally traversing into the housing; and
the secondary switch being externally mounted to the lower casing.

11. The bottle illuminating base as claimed in claim 10 comprises:
the power source, the illumination source, and the circuit board being internally mounted to the housing.

12. The bottle illuminating base as claimed in claim 10 comprises:
the bottle receiving portion being centrally positioned on the upper casing; and
the bottle receiving portion being dome-shaped, wherein the bottle receiving portion is pressed against a punt of a bottle via interference fit.

13. The bottle illuminating base as claimed in claim 10 comprises:
the upper casing and the lower casing being perimetrically connected to each other; and
wherein the upper casing and an affixed bottle are illuminated by the illumination source.

14. The bottle illuminating base as claimed in claim 10 comprises:
the three-way switch being a toggle switch.

15. The bottle illuminating base as claimed in claim 10 comprises:
the secondary switch being a button switch.

16. The bottle illuminating base as claimed in claim 10 comprises:
the three-way switch comprises a first electrical pathway and a second electrical pathway;
the illumination source and the power source being electrically connected in series through the first electrical pathway, wherein actuating the three way switch completes or breaks the first electrical pathway;
the illumination source, the secondary switch, and the power source being electrically connected in series through the second electrical pathway, wherein actuating the secondary switch completes or breaks the second electrical pathway;
